(19) United States
(12) Patent Application Publication
(10) Pub. No.: US 2025/0307307 A1
(43) Pub. Date: Oct. 2, 2025

(54) SEARCH ENGINE OPTIMIZATION FOR VECTOR-BASED IMAGE SEARCH

(71) Applicant: Adeia Imaging LLC, San Jose, CA (US)

(72) Inventors: Ning Xu, Irvine, CA (US); Jean-Yves Couleaud, Mission Viejo, CA (US)

(21) Appl. No.: 18/621,458

(22) Filed: Mar. 29, 2024

(51) Int. Cl. G06F 16/532; G06F 16/583; G06V 10/26; G06V 10/74; G06V 10/772

(52) U.S. Cl. CPC G06F 16/532; G06F 16/5838; G06V 10/26; G06V 10/761; G06V 10/772

(57) ABSTRACT

Methods, systems, and devices are disclosed for adjusting an image such that its vector representation more closely aligns with the vector representation of one or more intended search terms, and less closely aligns with the vector representation of one or more non-intended search terms. The method includes accessing an image and the intended and non-intended search terms. The image is iteratively adjusted using a machine learning system operating using a loss function that rewards adjustments resulting in an increase in the similarity score of the intended search terms, and penalizes adjustments resulting in an increase in the similarity score of the non-intended search terms. The loss function also penalizes increases in the perceptual loss between the input image and the adjusted image. The adjusted image may be uploaded to a sharing platform to improve the accuracy of search and organization of the adjusted image.

### FIELD OF DISCLOSURE

The present disclosure relates to vector-based searching, more particularly with respect to image searching and discoverability, and search engine optimization. In an embodiment, the present disclosure describes methods and systems for modifying or adjusting an image such that the vector representation of the adjusted image more closely aligns with intended search terms, and is less closely aligned with non-intended search terms.

### SUMMARY

Advances in searching technologies, such as for text searching and image searching, have increased in recent years with the rise in availability and applicability of machine learning and artificial intelligence. In particular, the evolution of vector-based search technologies in the realm of image search have had notable advancements. In some approaches, image search methods may depend on text metadata or tags associated with the images. The text metadata or tags may be manually input or automatically generated, and then indexed or stored in a manner that enables a search to be performed. In contrast, vector-based search technologies analyze the content of images directly. These technologies convert images into vector representations in a multidimensional space and assess relevance to corresponding vector representations of a search query (e.g., terms or other images) based on vector proximity and similarity, such as by using approximate nearest neighbor (ANN) algorithms.

While some advancements in image search technologies have sought to enhance image discoverability through improved tagging and search engine optimization, they have not addressed the specific needs of vector-based image search. For example, in one approach to image searching that relies on text metadata or tags, the performance of the search is limited by the accuracy and comprehensiveness of the text metadata or tags of the images. If an image is not tagged with a comprehensive and accurate list of tags, the search performance may be suboptimal. Additionally, this approach often requires manual input, which can be time consuming and may introduce additional issues with respect to accuracy and comprehensiveness.

In another approach, a system may use content based image recognition (CBIR) that analyzes the content of an image itself to extract features to be used for indexing and retrieval. This system may use vector-based search technology that represents the image and search queries as vectors in a multidimensional space. This approach may automate the image search process by automatically identifying images whose vector representations closely match those of the query (e.g., using ANN). This approach, however, has its own drawbacks and limitations. The static nature of an image's vector representation prevents the system from adjusting the vector representation to align more closely with a desired search term. That is, when an image is first analyzed it may have a vector representation that is closely matched with a set of search terms and corresponding similarity scores (e.g., the image vector representation is most closely aligned with the vector representation of an input search term “dog” with 0.70 similarity score, and the input search term “wolf” with 0.60 similarity score). If the user knows that the subject of the image is the user's dog, and is not a wolf, the user may wish to improve the classification of the image to increase the similarity score associated with “dog” and decrease the similarity score associated with “wolf.” However, the static nature of the image's vector representation may prevent the user from carrying out this modification. As a result, current vector-based search approaches pose a challenge for creators who wish to optimize their images to be more prominently surfaced in response to specific search queries.

Thus, there is a desire for an approach to vector-based searching that enables modification of an image, to enable the image's vector representation to reflect a more accurate or desired classification of the image. Embodiments of the present disclosure propose methods, systems, and devices for adjusting the visual appearance of an image so that its vector representation more closely aligns with targeted, positive, or intended search terms, and aligns less closely with negative or non-intended search terms, and also subtly adjusting the image to minimize or otherwise control the perceptual loss or change to the image's visual appearance. For some use cases, it may be desirable to ensure that a modified image remains visually similar or nearly identical to the input image, even while the vector representation is adjusted to align with particular search terms or keywords. For instance, a brand or business entity may desire for an image including their logo to be associated with certain search terms or keywords, and to also ensure that the logo remains recognizable in the adjusted image.

With the above noted issues in mind, an example method of this disclosure includes a system accessing an image for upload to a sharing platform. This image may be input by a user to a user computing device via a user interface. The method also includes determining a first keyword indicated as an intended search term for the image, and determining a second keyword indicated as a non-intended search term for the image. The intended search term may reflect a search term that the user desires the image to be more closely associated with (e.g., such that the search results for a search query including the intended search term is more likely or probable to include the image). The non-intended search term may reflect a search term that the user desires the image to be less closely associated with (e.g., such that the search results for a search query including the non-intended search term is less likely or probable to include the image). The method may then include inputting the image into a machine learning model or system comprising a generative model and discriminative model. The generative model is configured to iteratively make adjustments to the image and output an adjusted image. The discriminative model is configured to receive the adjusted image and determine the similarity scores for the intended search term and non-intended search term based on the adjusted image. The similarity score corresponding to each search term may refer to the likelihood that the image includes that search term (e.g., dog, mountain, etc.). The similarity score may also refer to a value associated with the search term and the image, such as a value indicating how similar the vector representation of the image is to the vector representation of the search term, and/or how correlated the vector representations are. For example, using an ANN calculation, the closest neighbors to a vector representation in distance can be determined. Various other definitions of the similarity score associated with each search term may be used as well. Additionally, the generative model is configured to modify the adjustments to the image based on a loss function, wherein the loss function is configured to: (i) reward adjustments that result in an increase in a first similarity score corresponding to the intended search term, wherein the first similarity score corresponds to a similarity between a vector representation of the adjusted image and a vector representation of the intended search term; (ii) reward adjustments that result in a decrease in a second similarity score corresponding to the non-intended search term, wherein the second similarity score corresponds to a similarity between the vector representation of the adjusted image and a vector representation of the non-intended search term; and/or (iii) penalize adjustments that result in an increase in perceptual loss of the adjusted image compared to the image. The method then includes causing the adjusted image to be uploaded to the sharing platform.

In some embodiments, the method includes causing the adjusted image to be uploaded to the sharing platform in response to determining that the similarity scores for the first keyword and second keyword have changed, thereby making the adjusted image more closely aligned with the first keyword (e.g., intended search term), and less closely aligned with the second keyword (e.g., non-intended search term). The method may include determining that the first similarity score of the intended search term for the adjusted image is greater than the first similarity score of the intended search term for the image, and determining that the second similarity score of the non-intended search term for the adjusted image is less than the second similarity score of the non-intended search term for the image. The method then includes causing the adjusted image to be uploaded to the sharing platform in response to these two determinations.

In some embodiments, there may be multiple intended search terms or first keywords, and/or multiple non-intended search terms or second keywords. In these embodiments, the loss function may further be configured to reward adjustments that result in an increase in respective similarity scores corresponding to any of the multiple first keywords or intended search terms, and to reward adjustments that result in a decrease in respective similarity scores corresponding to any of the multiple second keywords or non-intended search terms.

In some embodiments, the method may further include determining a segmentation mask for the image, the segmentation mask being configured to prioritize and deprioritize adjustments to portions of the image. The generative model may be configured to iteratively adjust the image based on the segmentation mask, wherein adjustments to a first portion of the image covered by or corresponding to the segmentation mask are prioritized over adjustments to a second portion of the image not covered by or not corresponding to the segmentation mask. In some embodiments, the segmentation mask for the image may be determined automatically based on the first keyword (or first keywords). For example, the first keyword may include the term “dog,” and a segmentation mask of the image may be determined based on the position of a dog within the image. In some embodiments, the segmentation mask may be determined based on input received via a user interface, the input comprising a selection of a portion of the image.

In some embodiments, the method may further include determining a perceptual loss threshold, the perceptual loss threshold comprising an acceptable amount of difference between the input image and the adjusted image. The method may then include causing the adjusted image to be uploaded to the sharing platform based on determining that the perceptual loss of the adjusted image compared to the image is less than the perceptual loss threshold.

In some embodiments, the system may prompt a user with candidate non-intended search terms in response to an input intended search term. For example, if a user inputs “dog” as an intended search term, the system may prompt the user to select “wolf” as a non-intended search term, because the image classifier may often confuse wolves and dogs, and/or may return the image of a wolf. The method may include presenting, via a user interface, the image and the first keyword indicated as the intended search term for the image; identifying, based on the image and/or the first keyword, a plurality of candidate second keywords; receiving, via the user interface, a selected candidate second keyword of the plurality of candidate second keywords; and identifying, as the second keyword indicated as the non-intended search term for the image, the selected candidate second keyword. In some embodiments, the system may also prompt the user with one or more candidate intended search terms, based on an analysis of the image.

In some embodiments, the system may present the image and adjusted image to the user, and may prompt the user to accept or reject the adjusted image. The method may include presenting, via a user interface, the image and the adjusted image. The method may then include presenting a prompt via the user interface for confirmation of the adjusted image, and based on receiving confirmation of the adjusted image via the user interface, causing the adjusted image to be uploaded to the sharing platform.

In some embodiments, the generative model may be configured to iteratively adjust the image by changing the color of one or more pixels of the image. Other adjustments may be made additionally or alternatively, such as modifying the intensity or other feature of one or more pixels or other portions of the image.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a simplified block diagram for a process of subtly adjusting an image such that an adjusted image's vector representation aligns more closely with an intended search term and aligns less closely with a non-intended search term, when compared to a vector representation of the initial input image, in accordance with some embodiments of the disclosure;

FIG. 2 shows an illustrative sequence diagram for the process shown in FIG. 1, in accordance with some embodiments of the disclosure;

FIG. 3 shows an example segmentation mask for an input image based on the intended search terms, in accordance with some embodiments of the disclosure;

FIG. 4 shows an example user interface of an input image, and adjusted image, intended and non-intended search terms, and similarity scores corresponding to the intended and non-intended search terms, illustrating that the intended search term similarity scores have increased while the non-intended search term similarity scores have decreased between the input image and the adjusted image, in accordance with some embodiments of the disclosure;

FIG. 5 shows another example user interface showing an input image, an adjusted image, and the rankings of each search term with respect to the input image and the adjusted image, in accordance with some embodiments of the disclosure;

FIG. 6 shows a simplified block diagram of a process for adjusting an input image, in accordance with some embodiments of this disclosure;

FIGS. 7-8 show illustrative devices and systems for enabling image adjustment, in accordance with some embodiments of this disclosure;

FIG. 9 is a flowchart of an example process for adjusting an image such that the adjusted image's vector representation aligns more closely with an intended search term and aligns less closely with a non-intended search term, when compared to the vector representation of the initial input image, in accordance with some embodiments of the disclosure.

### DETAILED DESCRIPTION

As noted above, it may be desirable to subtly adjust an image to make the corresponding vector representation of the image align more closely with the vector representations of desired or intended search terms, and to align less closely with the vector representations of undesired or non-intended search terms. Subtle adjustments to the image are described in further detail below, particularly with respect to the perceptual loss function. Making these adjustments may allow a user to tailor the image such that it appears in search results or is ranked higher based on desired search terms with greater probability when the search query includes the intended terms. For example, if a user wishes to organize their photo album in a particular way (e.g., to categorize the images based on their content), the user may desire for the images to have their vector representations modified to result in a more desirable ranking or sorting of the images based on certain intended search terms, but also for each image to remain perceptually similar or identical so as to avoid rendering the images less meaningful. Thus, it may be beneficial for embodiments of this disclosure to provide a subtle adjustment of the images to keep them perceptually similar or identical, while making more significant changes to the underlying vector representations of the images so they more accurately reflect the desires of the user. While many of the embodiments disclosed herein make reference to images and image searching, it should be appreciated that the principles disclosed may apply to any vector-based searching field, including for video, audio, and any other data that can be represented as a vector.

This disclosure may use the term keyword or search term interchangeably to refer to various different terms. For example, keyword or search term may refer to a single term (e.g., “dog”), multiple terms strung together (e.g., “big dog”), a key phrase (e.g., “big red dog”), a long tail keyword (e.g. “Clifford the big red dog”), or any other type of phrase or term.

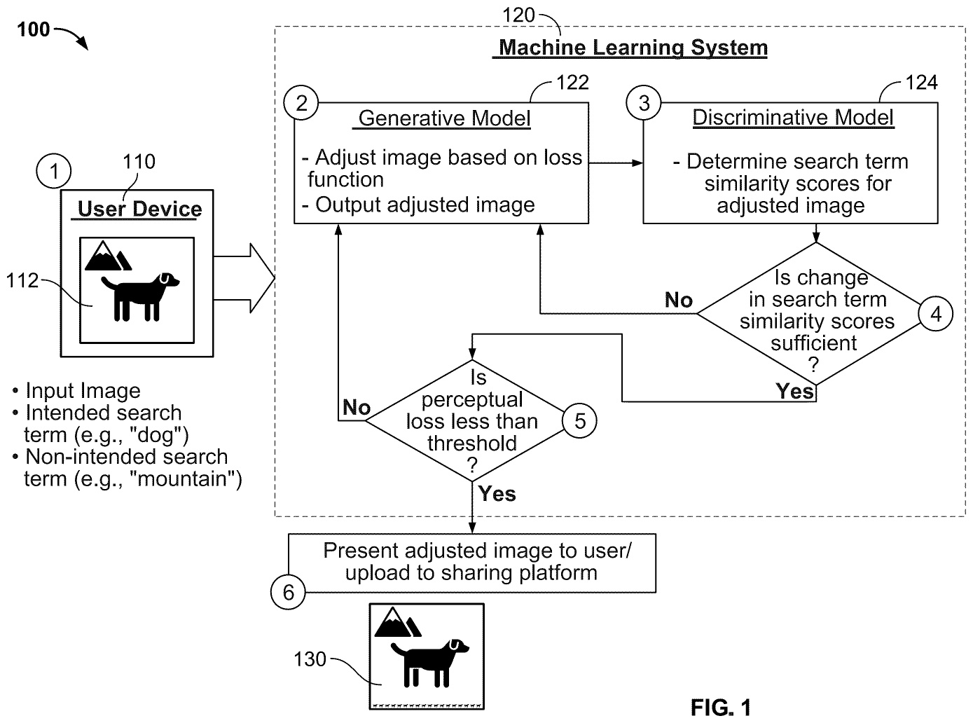

FIG. 1 illustrates a block diagram of an example process 100 for adjusting an image. For simplicity and in order to avoid overcomplicating the figure, the process 100 may leave out one or more steps, which are described in further detail with respect to other figures (e.g., generating and using a segmentation mask, the specific details of the loss function, etc.).

At step 1, the process includes a user device 110 receiving an input image 112. In some examples, the input image may have an initial vector representation associated with it. Alternatively, the image may be passed to a discriminative model (e.g., discriminative model 124) for analysis to determine the vector representation. The input image may also be analyzed (e.g., by a discriminative model such as discriminative model 124) to determine the closest search terms or keywords (e.g., using ANN on the respective vector representations), as well as the corresponding similarity scores of the search terms or similarity scores of the search terms with respect to the image 112. That is, the process 100 may include determining the search terms and corresponding similarity scores with respect to the image 112 (e.g., “dog” 0.70, “mountain” 0.65). The vector representation of the image 112 and/or the similarity scores of the search terms may be determined using any suitable machine learning model or system, such as discriminative model 124 shown in FIG. 1.

As used herein, various terms may all be used interchangeably to refer to the keyword or search term similarity scores. For example, keyword similarity score, search term similarity score, confidence value, probability score, confidence score, similarity value, and similarity score may all refer to the value that describes the similarity between a vector representation of the image and a vector representation of the keyword or search term itself. This value may be calculated using one or more algorithms, such as an ANN algorithm. Additionally, various embodiments may reference the embedding of the image and/or the embedding of a search term. An embedding may refer to the vector representation of the image or search term.

Referring back to FIG. 1, step 1 may also include receiving, via the user device 110, a first keyword indicated as an intended search term (e.g., “dog”) and a second keyword indicated as a non-intended search term (e.g., “mountain”). In the illustrated example, only one intended search term and one non-intended search term are determined. However, it should be appreciated that multiple intended and non-intended search terms may be used. In the illustrated embodiment, the user may desire for the image 112 to appear more often in the search results for queries that include the term “dog,” and to appear less often in the search results for queries that include the term “mountain.” That is, the user may desire for the image 112 to be associated more with the “dog” than the “mountain,” at least as it pertains to vector-based searching. In some embodiments, the intended and/or non-intended search terms may be manually input by a user vie the user device 110. Alternatively, in some embodiments, one or more of the intended and/or non-intended search terms may be automatically detected. For instance, the process 100 may include a computing device automatically analyzing the input image 112 using, for example, machine vision, to identify prominent objects in the image. In a further example, the image may be passed through an embedding process of a search engine to provide resulting embeddings. The resulting embeddings may then be used to compute a set of close queries in the query space, and then the system may reverse those queries into text and order them by word frequency. The prominent objects in the image may then be identified, and corresponding search terms may be associated with the image either automatically, or after being presented to the user for approval. This is described in further detail below.

At step 2, the process 100 includes passing the input image 110 to the machine learning system 120, in order to analyze and adjust the image 112. In FIG. 1, the machine learning system 120 is illustrated as including a generative model 122 and a discriminative model 124. However, it should be appreciated that the machine learning system may include other models, and/or may be distinct or separate from the generative model 122 and/or the discriminative model 124. The generative model 122 may adjust the input image 112 based on a loss function. In some examples, the loss function rewards adjustments that result in increased similarity scores for intended search terms, rewards adjustments that result in decreased similarity scores for non-intended search terms, and penalizes adjustments that result in perceptual loss between the input image and the adjusted image.

This combination of rewards and penalties is one example of the loss function, and it should be appreciated that in other embodiments, the loss function may operate with another combination of rewards and penalties for adjustments. For example, in one embodiment, the loss function may reward adjustments that result in increased similarity scores for intended search terms, without consideration for adjustments that result in decreased similarity scores for non-intended search terms and without consideration for adjustments that result in increased perceptual loss between the input image and the adjusted image. In another embodiment, the loss function may reward adjustments that result in decreased similarity scores for non-intended search terms, without consideration for adjustments that result in increased similarity scores for intended search terms and without consideration for adjustments that result in increased perceptual loss between the input image and the adjusted image. In another embodiment, the loss function may penalize adjustments that result in increased perceptual loss between the input image and the adjusted image, without consideration for adjustments that result in decreased similarity scores for non-intended search terms, and without consideration for adjustments that result in increased similarity scores for intended search terms. In another embodiment, the loss function may reward adjustments that result in increased similarity scores for intended search terms and may reward adjustments that result in decreased similarity scores for non-intended search terms, without consideration for adjustments that result in increased perceptual loss between the input image and the adjusted image. In another embodiment, the loss function may reward adjustments that result in increased similarity scores for intended search terms and may penalize adjustments that result in increased perceptual loss between the input image and the adjusted image, without consideration for adjustments that result in decreased similarity scores for non-intended search terms. In another embodiment, the loss function may reward adjustments that result in decreased similarity scores for non-intended search terms and may penalize adjustments that result in increased perceptual loss between the input image and the adjusted image, without consideration for adjustments that result in increased similarity scores for intended search terms.

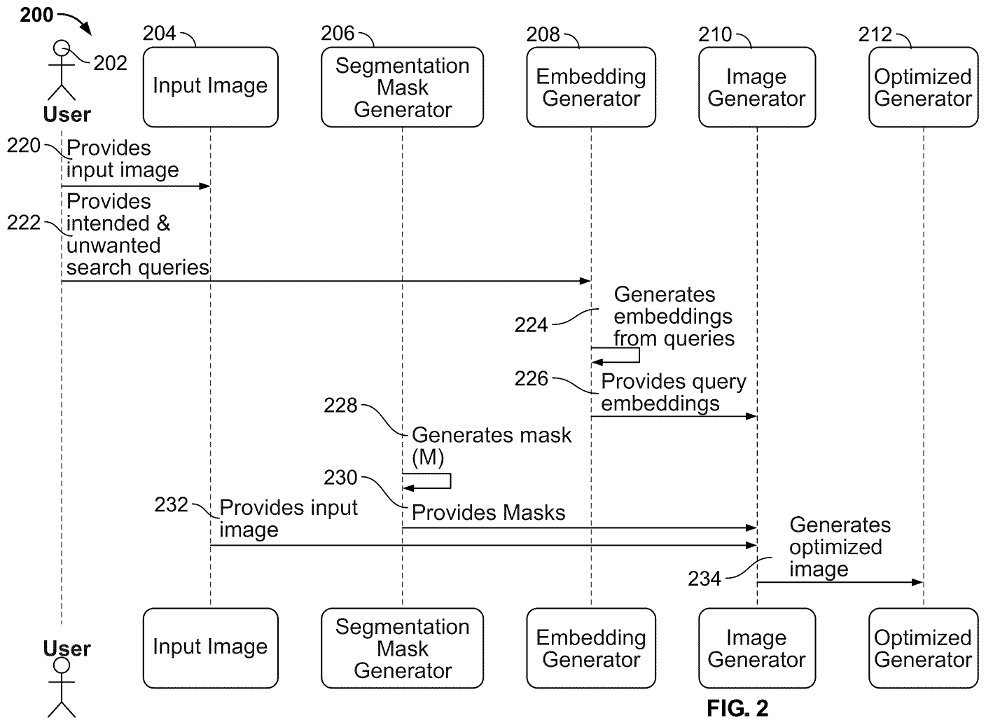

Adjusting the image may include modifying the visual appearance of the image (e.g., one or more pixels) change the image's vector representation. The loss function, and the process for adjusting the image, is described in further detail below, particularly with respect to FIGS. 2, 3, and 6. The generative model may adjust the image based on feedback from the discriminative model 124, so that the loss function performs correctly. The loss function may generally reward or prioritize the modification of pixels of the image that result in increased similarity score of the adjusted image having a vector representation that is close to the vector representation of the intended search term(s). The loss function may also generally reward or prioritize the modification of pixels of the image that result in a decreased similarity score of the adjusted image having a vector representation that is close to the non-intended search term(s). In other words, the loss function operates to make the adjusted image's vector representation more closely match the vector representations of the intended search terms (when compared to the vector representation of the input image), and to less closely match the vector representations of the non-intended search terms (when compared to the vector representation of the input image). The generative model may then output the adjusted image.

At step 3, the discriminative model 124 receives the adjusted image directly or indirectly from the generative model 122. The discriminative model may then classify and/or analyze the adjusted image to identify the adjusted image vector representation, as well as the associated keywords or search terms and their corresponding similarity scores. As noted above, these similarity scores reflect the similarity between the vector representation of the search term and the vector representation of the adjusted image.

At step 4, the process 100 includes determining whether the change in search term similarity scores is sufficient. That is, the user may input (or the system may determine) a threshold increase in the intended search term similarity score that must be met. For instance, the threshold may be that the similarity score of the intended search term (e.g., “dog”) must increase by some amount (e.g., base increase from 0.50 to 0.75), or may be a relative increase of 100% or improving to twice the similarity score from the input image to the adjusted image. Other threshold values are possible as well. The process 100 may also include determining whether a threshold decrease in the similarity score of a non-intended search term has been met. This determination may be similar to that described with respect to the increase in similarity score of the intended search term, but with respect to a decrease in the similarity score associated with the non-intended search term (e.g., “wolf” search term similarity score reduces from 0.50 to 0.25). In some embodiments, the determination at step 4 may include a combination of determining both that the increase in intended search term similarity score is above a threshold, and that the decrease in the non-intended search term similarity score is above another threshold.

If the change in search term similarity scores for the adjusted image is not sufficient, the process 100 proceeds back to step 2 and the generative model 122 performs another round of adjustments to the image. The loop of steps 2, 3, and 4 for generating further iterative adjustments to the image may continue until the change in the search term similarity scores are at, above, or below the respective thresholds as determined at step 4.

At step 5, the process 100 includes determining whether the perceptual loss between the adjusted image and the input image 112 is below a perceptual loss threshold. In some embodiments, the perceptual loss threshold may be automatically determined, may be manually input by the user via the user device 110, or may be determined in some other manner. The perceptual loss may be determined using a perceptual loss function that compares the adjusted image to the input image. In some examples, this determination may also use a segmentation mask, discussed in further detail below. The determination at step 5 ensures that the perceptual loss is less than the perceptual loss threshold, so that a user will deem the adjustments to the image imperceptible, or at least below an acceptable level. Ideally, the adjustments to the image 112 are so imperceptible that a user cannot even tell the difference. This may be desirable for a number of reasons. In one example, a user may want to organize a photo album to more accurately reflect a desired organization or ranking. The user may not want the images to change in any perceivable way, but may still desire for the images to be adjusted based on intended search terms so that they are better organized and are more easily searched using search queries that include intended search terms. In another example, a brand may desire for their logo to be associated more closely with certain search terms, but may not want the image of the logo to be changed such that it no longer reflects the brand. Making imperceptible adjustments to the image of the logo may enable the image to be found in a search for certain intended search terms more easily, while not changing the image so that it is no longer recognizable as being associated with the brand.

If the system determines that the perceptual loss is more than the perceptual loss threshold, the process 100 may proceed back to step 2 to make further adjustments to the adjusted image to reduce the perceptual loss, while maintaining greater than the threshold change to the similarity scores associated with the intended and non-intended search terms. That is, steps 2, 3, 4, and 5 may be repeated in a loop until both the changes to the search term similarity scores are greater than the respective thresholds, and the perceptual loss is less than the perceptual loss threshold. While steps 4 and 5 are illustrated in a particular order, is should be appreciated that they may be switched, and/or one or more of the steps shown in FIG. 1 may be performed in a different order than is shown or may be performed simultaneously as co-optimization processes. For example, steps 4 and 5 may be performed simultaneously such that two loss functions are determined (e.g., one for the search term similarity scores and one for the perceptual loss), and both loss functions feed into the generative model 122.

At step 6, once the system determines that the adjusted image has a corresponding vector representation that results in an increase in the intended search term similarity score that is greater than the respective threshold, a decrease in the non-intended search term similarity score that is greater than the respective threshold, and a perceptual loss that is less than the perceptual loss threshold, the adjusted image 130 may be acted on in a number of ways. In one embodiment, the adjusted image 130 may be provided to the user device 110 for preview by the user. Additionally, the intended and non-intended search terms and their corresponding similarity scores may also be provided to the user device 110 for preview. Further, the perceptual loss may be provided to the user device 110. The user device may then prompt the user for approval of adjusted image. If the user desires further adjustments, the process may continue through steps 2, 3, 4, 5, and 6 with updated values for the thresholds to be used. If the user approves, the adjusted image 130 may be uploaded to an image sharing platform, social media platform, e-commerce platform, or other device or system.

FIG. 2 illustrates a sequence diagram 200 for adjusting an image such that the adjusted image's vector representation aligns more closely with an intended search term and aligns less closely with a non-intended search term, when compared to the vector representation of the initial input image. At step 220, a user 202 wishing to perform an image optimization (e.g., to make the image optimized for use by a search engine), the user provides the input image. The user also provides a list of intended and/or non-intended search terms or search queries at step 222. These inputs may be made at a user device via a user interface.

The input image may be in any suitable format, size, resolution, etc. The input image may also have an associated vector representation, and a set of keywords or search terms and corresponding search term similarity scores. In some embodiments, when the user is uploading the image, the user may also be prompted to enter terms related to what they want the image to be associated with. These terms are then treated as the intended search terms. Additionally, the user may be prompted to enter terms related to what they do not want the image to be associated with. These terms may then be treated as the non-intended search terms.

In some embodiments, the user may manually input one or more of the intended and/or non-intended keywords or search terms. In other embodiments, the system may automatically provide suggestions for the intended and/or non-intended keywords or search terms based on the image content and/or based on what a search engine analyzes the image as including. The user may then accept, modify, or reject the suggestions, in order to generate the intended and non-intended keywords or search terms.

At 224, the embedding generator 208 may generate one or more embeddings (or vector representations) for the input image, intended search terms, and/or non-intended search terms. This may also include determining the search term similarity scores for each intended and/or non-intended search term. This step may be performed by the discriminative model 124, described with respect to FIG. 1. At step 226, the embedding generator 208 may pass the embeddings to the image generator 210.

At step 228, the segmentation mask generator 206 may generate a mask for the input image 204. The segmentation mask may highlight one or more areas of the input image 204 that are relevant to the intended and/or non-intended search terms. The segmentation mask may include an array or set of weights or values corresponding to each pixel or other subset of the input image. These values may be used in other steps of the process such as determining which pixels of the image to adjust (e.g., using the generative model 122), determining the amount of perceptual loss, and more. These features are described in further detail below.

The segmentation mask generator 208 may generate the segmentation mask for the input image 204 based on the intended and/or non-intended search terms. For example, if the intended search term is “dog,” the segmentation mask may be generated to cover or otherwise correspond to the background of the input image surrounding the dog. In some embodiments, the system may generate the segmentation mask using machine vision, such as by analyzing the input image 204 to identify one or more objects in the image, and then matching one or more of the identified objects to an intended and/or non-intended search term. In some embodiments, the segmentation mask may be generated using user input at a user device (e.g., user device 110). For instance, the user 202 may draw the segmentation mask on a user interface of the user device. Additionally, the user 202 may identify one or more candidate objects in the input image 204 by selecting portions of the image on the user interface. In another embodiment, the system may automatically identify one or more candidate objects in the image, and present the candidate objects to the user for selection. The user may then select one or more candidate objects, and the system may automatically generate a segmentation mask based on selected object(s).

In some embodiments, the system may generate multiple segmentation masks. Each segmentation mask may correspond to an identified object, an object selected via the user interface, an intended search term, or a non-intended search term. The system may then combine the multiple segmentation masks into a single combined segmentation mask. At step 230, the segmentation mask may be provided to the image generator 210.

At step 232, the system provides the input image 204 to the image generator 210. Image generator 210 receives the intended and non-intended search term vector representations (e.g., query embeddings), the segmentation mask(s), and the input image 204. The image generator 210 then performs an adjustment to the input image (described above and below). The adjustment may include iterative modification to the pixels or other portions of the image based on a loss function, wherein the loss function rewards adjustments that result in higher similarity scores for intended search terms, lower similarity scores for non-intended search terms, and limited perceptual loss. In some examples, the user or the system may rank one or more of the intended and/or non-intended search terms, and the loss function may prioritize changes to higher ranked search terms over changes to lower ranked search terms. At step 234, the image generator 210 then generates the adjusted image (or optimized image) 212. The adjusted image 212, when analyzed by a discriminative model such as model 124, includes either or both of (a) higher similarity scores for the intended search terms and (b) lower similarity scores for the non-intended search terms when compared to the input image 204.

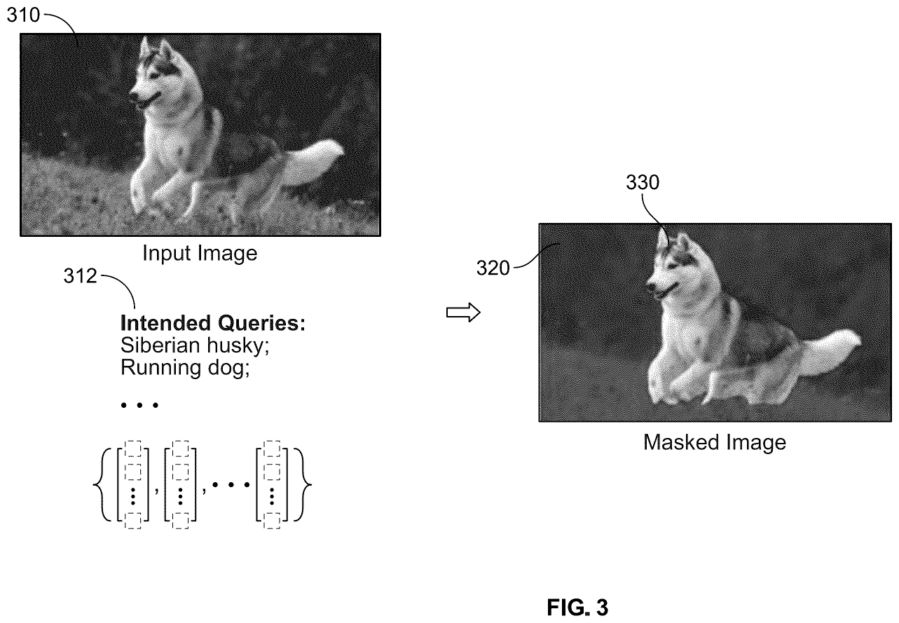

FIG. 3 is a visualization of a segmentation mask based on one or more intended search terms. A segmentation mask may include a set of values for each pixel or other portion of the image that can be used when analyzing or adjusting the image, determining a perceptual loss between an input image and an adjusted image, and more.

In some embodiments, the segmentation mask may be used by the image generator (e.g., image generator 210), machine learning system (e.g., generative model 122 and/or discriminative model 124), and/or another device or system when analyzing or adjusting the image. For example, the segmentation mask indicates which portion or portions of the image are more important than others (and should therefore remain unchanged), and which portions can be adjusted or manipulated more readily while having a limited impact on the perceptual difference between the input image and adjusted image. In FIG. 3, for example, the mask 320 covers or corresponds to the background of the input image 310, while leaving the subject “dog” 330 uncovered. In this example, the segmentation mask 320 may comprise a set of weights or values for each pixel covered by the mask that indicates a greater likelihood of being adjusted during optimization of the image, while the weights or values for the portion of the image covered by the subject dog 330 (and therefore uncovered by the mask 320) indicate a lower likelihood of being adjusted during optimization. That is, the segmentation mask 320 attempts to prevent or reduce the likelihood of adjustment of the input image 310 for the portions uncovered by the mask (e.g., the subject dog 330), while increasing the likelihood that the image is adjusted in the portion covered by the mask 320. Because the dog 330 is the subject of the image and is therefore the likely focal point of the image, any adjustment to the dog 330 may cause a greater perceptual loss, and therefore a noticeable difference in the image when viewed by a user. Since an object of the optimization may be to make adjustments to an image without causing noticeable differences, the dog 330 may be masked or protected from significant changes to help reduce the perceptual loss. However, the optimization also factors in changes to the similarity scores of the intended and non-intended search terms, so in some embodiments it may be practical or beneficial to adjust the portion corresponding to the dog 330.

In this disclosure, the segmentation mask 320 may be described as “covering” the background of the input image 310. However since the concept of the segmentation mask in practice is a set of values or weights for the entire image (or for some portion of the image), it should be appreciated that this description is one of convenience, and it should be understood that the segmentation mask may be described in other ways as well. For example, the segmentation mask may instead be described as “covering” the subject image (e.g., the subject dog 330), while leaving the background “uncovered.” Whether the segmentation mask is described as covering the background, or covering the subject or some other portion of the image, it should be appreciated that the segmentation mask comprises a set of weights or values for each pixel or portion of the image that can be used for various purposes as described herein.

For instance, the segmentation mask may be used to increase or decrease the likelihood that a given pixel or portion of the image is adjusted during the process of determining the adjusted image. That is, the machine learning system 120, and/or specifically the generative model 122, may use the segmentation mask to weight where adjustments to the image should be made, thereby increasing the likelihood of adjustment to portions of the image covered by mask (e.g., the background) while decreasing the likelihood of adjustment to portions of the image uncovered by mask (e.g., the subject dog 330).

In some embodiments, the segmentation mask may be used to increase or decrease the weights applied by the perceptual loss function for each pixel or portion of the image. That is, perceptual loss in the background 320 may be more acceptable (and thus carry less weight in the perceptual loss calculation) than perceptual loss in the subject dog portion 330.

The segmentation mask may be generated by the segmentation mask generator 206, and/or by some other device or system. In some embodiments, the segmentation mask may be automatically generated based on the intended search terms, the non-intended search terms, and/or a combination of both. For example, the user may input the intended search terms and/or non-intended search terms, and the system may use machine vision or some other image analysis of the input image to identify one or more portions of the input image (such as using bounding boxes). The system may then associate one of more of the bounding boxes with an intended search term or a non-intended search term. In some embodiments, the system may employ the user of AI or machine learning to estimate, guess, or otherwise determine which objects are the most prominent in the input image. These objects may then be matched with the intended search terms and/or non-intended search terms.

In some embodiments, the user may input the segmentation mask via a user interface (e.g., via a user interface of user device 110). For instance, the user may draw the segmentation mask on the input image to identify the subject he or she cares about. Additionally, the user may input a connection between one or more intended search terms and a portion of the image (e.g., selecting the intended search term “dog” and identifying the portion of the input image that includes the dog).

In some embodiments, the system may generate the segmentation mask based on a combination of automatic analysis and user input. For instance, the segmentation mask generator may identify portions of the image that include subjects, objects, the background, etc. These portions may then be presented to the user for selection via the user interface. The user may then select one or more of the identified portions to associate with one or more of the intended and/or non-intended search terms.

In some embodiments, the system may generate a segmentation mask for each intended search term and/or each non-intended search term. The system may then combine the plurality of segmentation masks into a single segmentation mask (e.g., via union of the masks) to be used for image adjustment, perceptual loss calculations, etc.

In one embodiment, all masks corresponding to intended search terms are combined into a singled intended search term mask, and all masks corresponding to non-intended search terms are combined not a single non-intended search term mask. The intended search term mask and non-intended search term mask are then combined by cancelling the intersection of the two masks.

When performing image adjustment, pixels masked by the intended search term mask may have larger weights (indicating a lower likelihood of being adjusted), while pixels covered by the non-intended search term mask may have smaller weight values (indicating a higher likelihood of being adjusted). In some examples the weights may be reversed (e.g., a low weight may indicate a lower likelihood of being adjusted, and vice versa).

When calculating the perceptual loss between the adjusted image and the input image, pixels masked by the intended search term mask may have larger associated weights (indicating a higher impact on the perceptual loss calculation), while pixels covered by the non-intended search term mask may have smaller associated weights (indicating a lower impact on the perceptual loss calculation). In some embodiments, the weights may be reversed (e.g., the intended search term mask may have lower weights indicating changes to corresponding pixels have a higher impact on the perceptual loss function, and vice versa).

The illustrated example of FIG. 3 shows that the system may make greater changes or may prioritize or reward adjustments to the background 320 more than adjustments to the subject 330. However, in some examples, these considerations may be reversed. For some classifications of objects, it may be desirable to make a greater modification to the subject 330 than the background 320. For example, if the background of the image is a solid color while the subject of the image has a lot of detail, it may be desirable to make changes only to the subject since any change to the background would result in high perceptual loss. If the subject is very detailed, it may be that even major adjustments would not be perceptible. In another example, a user may input an image of a horse that includes shadows that make the horse appear to have stripes on its back. The image may initially have a high similarity score for the term “zebra.” The user may find this correlation undesirable, so the system may adjust the shadows in the image to look less like stripes to minimize the zebra component. In this example, the system may modify pixel(s) related to the subject rather than the background.

In some examples, the segmentation mask may include weights that prevent adjustment of certain portions of the image entirely. That is, the segmentation mask may prevent adjustment of certain portions, while enabling adjustment of other portions. This may enable a user to select which portions of the input image that are able to be adjusted, and prevent other portions from changing at all.

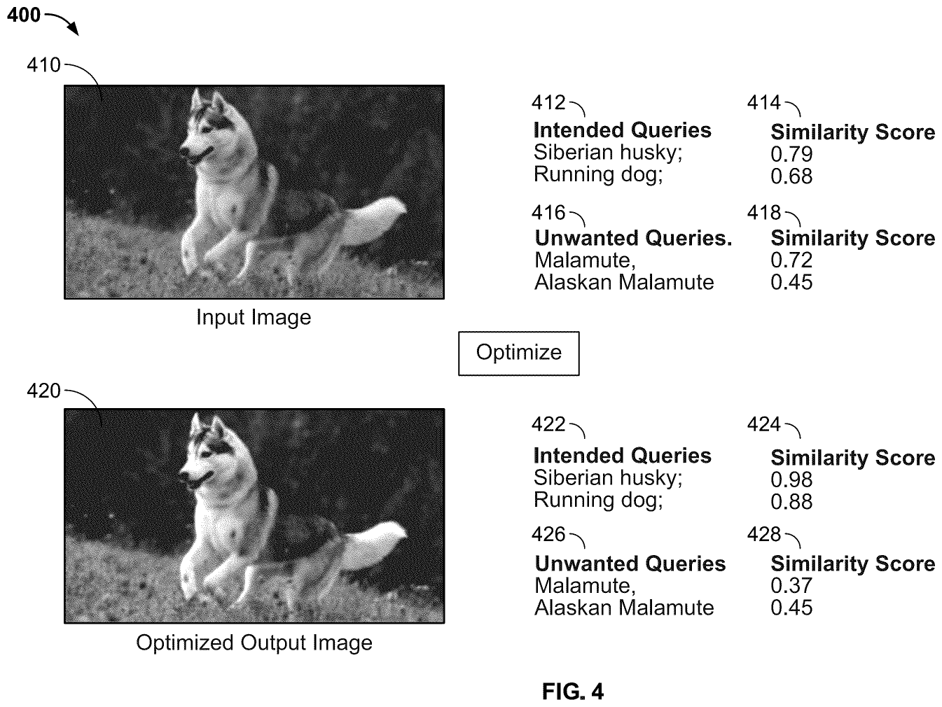

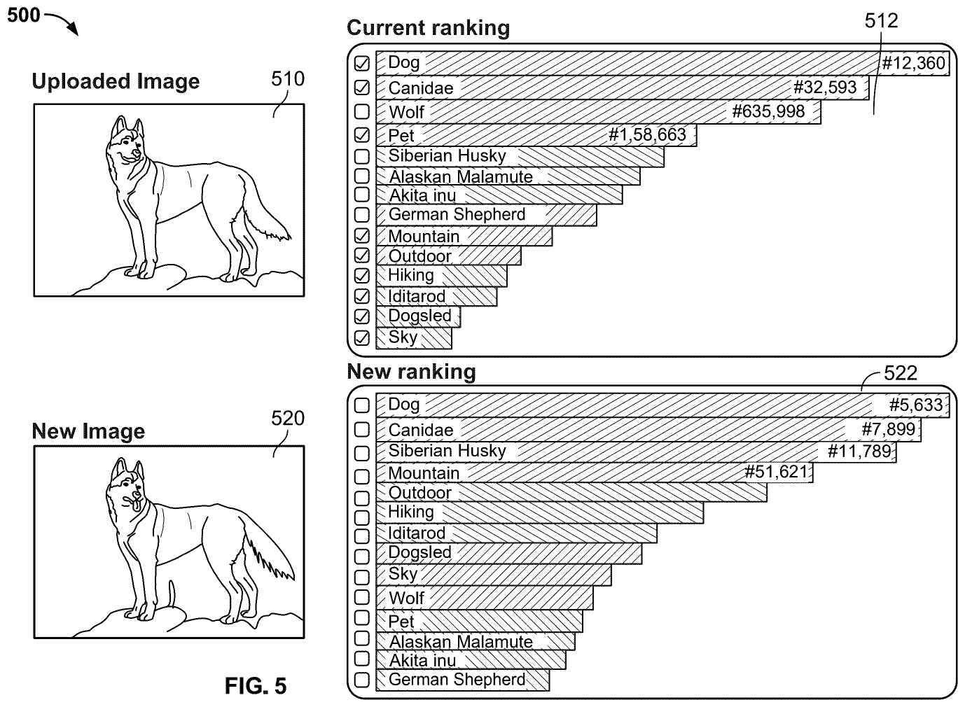

FIGS. 4 and 5 illustrate example user interfaces 400 and 500 respectively, each showing an input image and an adjusted image, along with the corresponding intended search terms or keywords, non-intended search terms or keywords, and corresponding similarity scores.

In some embodiments, the system may provide a drag-and-drop or file selection interface (via the user device) that enable a user to upload an image they wish to optimize. The user interface may include a preview pane to display the image before any adjustments or optimization is performed, and also include a preview pane for displaying the adjusted or optimized image. The user interface may also provide text input fields to enter the keywords indicated as the intended and non-intended search terms. In an embodiment, the input field for intended search terms may be mandated, while the input field for non-intended search terms is optional. The user may add search terms one by one, or may input them all together in each text input field, with some specified delimiters. In some examples, the system may prompt one or more of the intended or non-intended search terms. That is, the system may automatically identify one or more candidate search terms (such as using machine vision), and may prompt the user to select one or more of the candidate search terms as intended or non-intended search terms. In some examples, the system may prompt the user to select one or more candidate non-intended search terms based on the intended search terms. For instance, if a user selects dog breed A (e.g., Siberian Husky) as an intended search term, the system may identify breed B (e.g., Alaskan Malamute) as being a similar breed that is often confused for breed A, by computing the embeddings for the image and determining a component that is close to both husky and malamute. The system may suggest selecting dog breed B as a non-intended search term in this case. In some embodiments, the system may also enable automatic selection of one or more groups of search terms as either intended or non-intended search terms. For instance, if a user selects term A, the system may prompt the user to also select terms B, C, and D as intended search terms as well.

In some embodiments, after receiving the intended search terms and/or non-intended search terms, the system may provide to the user a visual indication of a segmentation mask for each search term. The user interface may include selectable search terms, such that when the user selects a first term, the corresponding segmentation mask for that search term is presented via the user interface. The user may also be presented with the union mask of all masks for the intended search terms, and/or the union mask of the masks for all non-intended search terms. In some embodiments, the user interface may also include one or more tools to enable the user to manually draw and/or adjust one or more of the segmentation masks, particularly if the user wants to refine the areas of the image that will be prioritized for adjustment during the optimization process.

In some examples, the user interface may also present the user with the similarity scores corresponding to each keyword or search term. The user may determine not to optimize the image if the similarity scores for the intended search terms are high enough and the similarity scores for the non-intended search terms are low enough. Additionally, when the adjusted or optimized image is determined and presented via the user interface, the user can also be presented with the updated similarity scores for the search terms. In some examples, the user may have the option to request further refinement or adjustment of the adjusted or optimized image. The user may provide further user input (e.g., refining the segmentation mask, selecting a portion of the image for further adjustment, selecting a search term to optimized further, etc.), and the process may be repeated using the adjusted image as the input image. The system may determine a further adjusted image (or readjusted image) that may then be compared to either or both the initial input image, and the intermediate adjusted image on which the user requested further refinement. This process may continue until the user is satisfied.

In some examples, the user may interactively set or adjust the parameters for the optimization process. For instance, the user may balance between intended search term similarity score improvement and visual similarity (e.g., perceptual loss). The user interface may also include one or more buttons or selectable icons to initiate the optimization process and to save or discard changes. In some examples, the user interface may also present a section where the adjusted or optimized image is displayed alongside the original image for comparison by the user. The user interface may also include a sliding window or other user interface element to illustrate the differences between the input image and the adjusted or optimized image.

Referring to FIG. 4, the user interface 400 includes a display of input image 410, the intended search terms 412, the corresponding search term similarity scores or similarity scores 414, the non-intended search terms 416, and the corresponding search term similarity scores 418. The user interface also includes the optimized image 420, the intended search terms 422, the corresponding search term similarity scores or similarity scores 424 after optimization, the non-intended search terms 426, and the corresponding search term similarity scores or similarity scores 428 after optimization.

The processes described above with respect to FIGS. 1-3 may be applied here as well. For example, the user may provide input image 410, intended search terms 412, and non-intended search terms 416. The user may desire to improve the similarity score between the intended search terms 412 and the input image 310, and to reduce the similarity score between the non-intended search terms 416 and the input image 410. The input image 410 may be analyzed to determine the corresponding similarity scores (or search term similarity scores) 414, 418 for each of the intended and non-intended search terms 412, 416. This analysis may include using a discriminative model (e.g., discriminative model 124) to determine the vector representation of the image 410 and the vector representations of the intended and/or non-intended search terms 412, 416. The similarity scores for each search term may then be determined by using one or more algorithms or calculations (e.g., ANN) based on the vector representations of the image 410 and the search terms 412, 416. The user interface 400 may present the similarity scores as color coded values, on a gradient, or otherwise visually distinct such that high similarity scores are visually distinct from low similarity scores.

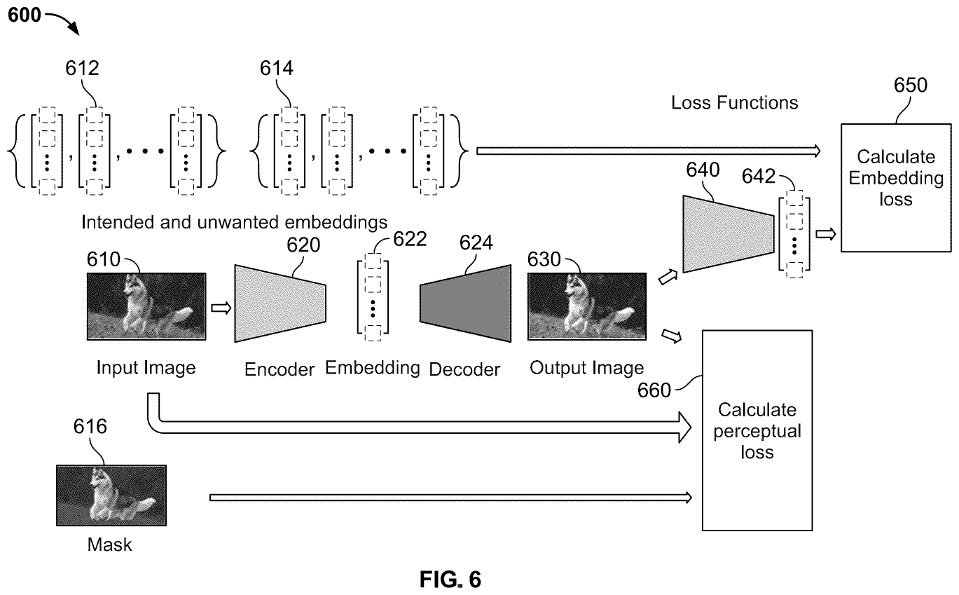

The system may then adjust the input image 410 using a machine learning system, such as system 120 described with respect to FIG. 1, and/or using the process described with respect to FIG. 6 below. The adjusted or optimized image 420 may then be output to the user interface, along with updated search term similarity scores 424, 428 corresponding to the intended and non-intended search terms 422, 426. The user may then be prompted to accept the adjusted image 420, and/or may be given the opportunity to request additional adjustments to the image. In that case, the adjusted image may be readjusted with new thresholds, so that a further adjusted image may be generated. The user may also be presented with the option to upload the adjusted image to a sharing platform, or take some other action with respect to the adjusted image.

FIG. 5 illustrates another example user interface 500. In this embodiment, the system may automatically identify a plurality of candidate search terms 512 for the input image 510, such as by determining the embeddings of the input image 510 in query space as returned by a search engine. The user interface may then enable the user to select one or more of the candidate search terms 512 that he or she wants to use as intended search terms. The input image 510 may then be adjusted based on the selected search terms from the list 512. Upon uploading the input image 512, the system may determine the vector representation of the input image 510, and derive a set of embeddings. These embedding may then be converted into candidate search terms 512. The candidate search terms may be ranked or ordered based on their respective similarity scores to the input image. In the illustrated example of FIG. 5, the input image 510 returns the candidate search terms “dog,” “Canidae,” “wolf,” “pet,” etc. This list of candidate search terms 512 is presented to the user, including ranking information representing how the input image 510 would be positioned in the search results based on the listed query if the input image 510 is not modified. The user may then elect to select or keep unselected certain search terms form the candidate list 512. The system may then generate the adjusted image 520 based on the selected intended search terms, and provide the adjusted image 520 via the user interface along with the updated rankings of the search terms.

If the adjusted image 520 returns new reverse search terms, these new search terms may be added to the list 522. Note that in the example of FIG. 5, the adjusted image 520 is shown with noticeable differences from the original image 510. In other examples, however, the techniques proposed herein may not produce any perceivable or significantly noticeable differences between the images.

In some embodiments, the user interface may also enable the user to specify the weight for one or more search terms of the candidate search terms 512, and this weight will be considered during the optimization process. Additionally, the user-selected weights may also affect the perceptual loss calculation.

FIG. 6 is a block diagram illustrating how an input image is adjusted or altered according to embodiments of the present disclosure. The process shown in FIG. 6 may operate according to an optimization formula that may be represented as:

$${I}_{optimlzed} = f ( I , M , \{ {\vec{V}}_{Intended} \} , \{ {\vec{V}}_{N on - Intended} \} )$$

### Subject to:

1. min Σ_{\vec{v}∈{\vec{V}}_{_{Intended}}_{}}d({\vec{I}_{optimized}, \vec{v}})—minimizing the distance between the vector representation of the optimized image and the intended search term vectors
2. max Σ_{\vec{v}∈{\vec{V}}_{_{Non-Intended}}_{}}d({\vec{I}_{optimized}, \vec{v}})—maximizing the distance between the vector representation of the optimized image and the non-intended search term vectors
3. D(I_{optimized}, I)≤∈—limiting the visual difference between the input image and the optimized (or adjusted) image, where D is a function measuring the visual difference and ∈ is the perceptual loss threshold

### Wherein:

I is the input image.
M is the segmentation mask generated from the search terms.
{\vec{V}_{Intended}} is the set of vectors representing intended search terms.
{\vec{V}_{Non-Intended}} is the set of vectors representing non-intended search terms.
\vec{I} is the vector representation of the input image.
\vec{I}_{optimized} is the vector representation of the optimized image.
ƒ(·) is the optimization function using the machine learning system.

In this formulation, the segmentation mask M is included in the optimization function f, indicating that the segmentation mask plays a role in the optimization process. The optimization function incorporates the segmentation mask to guide the modification of the image in alignment with the intended search terms while also disassociating from the non-intended search terms. The segmentation mask informs where in the image to apply changes more significantly, helping to ensure that the optimization respects the semantic content of the image as related to the search terms.

The model 600 of FIG. 6 illustrates how backward propagation can be used to obtain the optimized or adjusted image. As shown, the user may input the input image 610, the intended search terms, and the non-intended search terms. The intended and non-intended search terms are represented as embeddings 612 and 614 respectively (e.g., vector representations of the search terms). The input image 610, the intended search terms, and/or the non-intended search terms are used to generate the segmentation mask 616, such as is described above with respect to FIG. 3.

The encoder 620, embeddings 622, and decoder 624 comprise a section of the machine learning system by which the adjustments are made to the input image 610. In one example, if the encoder used by the search engine (e.g., a search engine associated with the sharing platform) is known, the same encoder may be used for encoder 620 to extract the feature embeddings of the input image and search terms. In one example, a method may include determining the encoder used by the search engine associated with the sharing platform to which the image will be uploaded (or other entity to which the adjusted image will be shared), and then using the same encoder in the generative and/or discriminative models 122 and/or 124, and/or as encoder 620 and encoder 640 in FIG. 6. Alternatively, if the encoder of the search engine or sharing platform is not known, or the optimization process is being performed generally without reference to a specific search engine or sharing platform, any suitable encoder may be used to obtain the embeddings of the image and/or search terms, such as an encoder utilizing a Contrastive Language-Image Pre-training (CLIP) model.

In the illustrated example, weights of the encoder 620 may be fixed so that the encoder is not trainable and will not be updated by error propagation. The encoder 620 processes the input image to determine the embeddings 622 (e.g., the vector representation of the input image). The embeddings 622 of the image are then modified by adding a small delta so that they modified embeddings of the image align more closely with the embeddings of the search terms 612, 614. The decoder 624 then takes the modified embeddings and outputs an adjusted image 630. To determine which pixels or portions of the image to modify, the model 600 may attempt to find a solution to the optimization function noted above. The model 600 may consider modifying low information carrying pixels first (e.g., background pixels, then subject pixels). In some embodiments, there may be one or more connections between the encoder 620 and the decoder 624 at one or more layers, such as may be found in a U-Net architecture.

The output image (e.g., adjusted image) 630 is then passed through the encoder 640, which may be the same as the encoder 620, to obtain an updated embedding or vector representation 642 of the adjusted image 630. The updated embedding 642 of the adjusted image 630 is compared to the input embeddings 612 and 614 to determine an embedding loss 650 (or gain). The embedding loss reflects how the similarity scores for the intended search terms and non-intended search terms have changed from the input image 610 to the adjusted image 640.

Additionally, the adjusted image 630 is compared with the input image 610, using the segmentation mask 616, to calculate the perceptual loss 660. The segmentation mask 616 provides weights for each of the pixels, such that changes in some areas of the image have less of an impact than changes in other areas with respect to the overall perceptual loss determination. The perceptual loss 660 and the embedding loss 650 may both be used to calculate the gradient, which may be used by the encoder 620 and/or decoder 624. In one embodiment, the encoder weights are fixed, and the decoder is updated iteratively using back propagation. Additionally, the perceptual loss and embedding loss may be used to update the weights of the decoder 624 using error propagation. That is, the perceptual loss and embedding loss provide feedback that is used by the model 600 to converge on an optimal solution (e.g., the output image) for the optimization function noted above.

To determine whether the model 600 has arrived at an optimal or desired output image, the model may determine whether there has been an increase in the intended search term similarity score that is above a threshold, whether a decrease in the non-intended search term similarity score is above a threshold, and/or whether there has been a combination of increase in the intended search term similarity score and a decrease in the non-intended search term similarity score. In some embodiments, the determination of whether a sufficient change in the similarity scores of the intended and/or non-intended search terms may include determining (i) whether there has been a threshold change in the combined similarity scores of all intended and/or non-intended search terms, (ii) whether there has been a threshold change in the average similarity score of all intended and/or non-intended search terms, or (iii) where the search terms are ranked, whether there has been a threshold change in the similarity scores of the intended and/or non-intended search term similarity scores when weighted according to the rankings of the search terms (e.g., a change in a higher ranked intended search term may have more of an impact than a change to a lower ranked intended search term). Additionally, as noted above with respect to FIG. 1, determining whether the model 600 has arrived at an optimal or desired output image may include using a loss function that factors in certain criteria. As indicated in the embodiment described above, the model 600 may consider all three of (i) a threshold change (e.g., increase) in the similarity scores for intended search terms, (ii) a threshold change (e.g., decrease) in the similarity scores for non-intended search terms, and (iii) less than a threshold change (e.g., increase) in the perceptual loss between the input image and the adjusted image. However, it should be appreciated that the model 600 may instead operate using a loss function that considers, rewards, and/or penalizes adjustments that result in any one or more of these three factors. In embodiments where only one or two of the above noted factors are considered, the model 600 may or may not consider the other factor(s) in the loss function.

In some embodiments, the techniques described herein may be used in connection with an AI input text-to-image system. A system that enables text-to-image generation and/or any other image creation step, the methods and systems described herein may enable the user to optimize their generated image for search engine optimization by providing intended search terms and non-intended terms. In one embodiment, the techniques disclosed herein could be implemented as an additional step for the generative AI system, wherein the AI system would first use text-to-image generation to generate an image, and then perform the techniques described herein to optimize the image based on intended and/or non-intended search terms. The AI system may include an additional entry field for the intended and/or non-intended search terms.

In some embodiments, the input image is preprocessed by resizing the image to a particular resolution, before processing the image to obtain the embeddings. The adjusted image will have the same processed resolution, and may then be processed back to the original resolution of the input image through scaling. In one embodiment, the scaling algorithm will be optimized in a way that if the scaled image is undergoing the resizing preprocessing again, it will minimize embeddings changes.

The principles applied herein and described with respect to image-based vector search optimization may also apply to other areas, such as video or audio. For video, the system may treat each frame of the video as an image. Additionally, the system may pass data or share information across the analysis of multiple images, such as by considering changes in the vector representations across multiple successive frames of the video. This may enable a video to appear higher in the ranked search results for particular targeted search terms. In some examples, the techniques described herein may be used to modify the thumbnail of a video, wherein the thumbnail is used for indexing or searching (e.g., to rank the video higher via thumbnail adjustment when a search query includes the intended search terms). For audio, if the audio has a vector representation, the same techniques for vector representation modification may be used. The audio may be modified as imperceptibly as possible so that the adjusted audio vector representation is closer to one or more intended search terms, and is farther from one or more non-intended search terms.

The examples and embodiments herein are described with respect to image modification for the purpose of optimizing an image for use with a search engine. However, the principles described herein may be used in connection with multiple applications. In one example, as noted above, a user may want to organize their photo album in a more desirable way. The techniques described herein may be used to adjust one or more images of the photo album (e.g., just the cover photo for each category, all photos, all photos that include a certain subject, etc.). The images can be adjusted such that they are not perceptibly changed when viewed by the user, but are more accurately organized and more easily searchable by the user. For instance, the photo album images may be subtly adjusted so that all images that include the user's face, a certain location, a certain subject, etc. are more closely grouped or associated with each other, and are thus more likely to be found in a search for a given term. In another example, the described techniques may be used for search engine optimization to enable users to optimize their images to appear more prominently in search results. The described techniques may be used in the context of social media platforms, particularly those that rely on image sharing and discovery, where users frequently search for visual content. The described techniques may be used in the context of e-commerce platforms, to help customers find products through visual searches, improving shopping experience and potentially increasing sales. The described techniques may be used in the context of digital marketing and SEO firms, which may specialize in search engine optimization to help clients' images become more discoverable, directly affecting digital marketing strategies. The disclosed techniques may be used in the context of stock photography websites, which may make their inventory more accessible and relevant to specific search queries, enhancing customer satisfaction and retention. And the disclosed techniques may be used in connection with artificial intelligence (AI) and machine learning (ML) solutions providers, which may integrate the described techniques to generate images that better align with the image search.

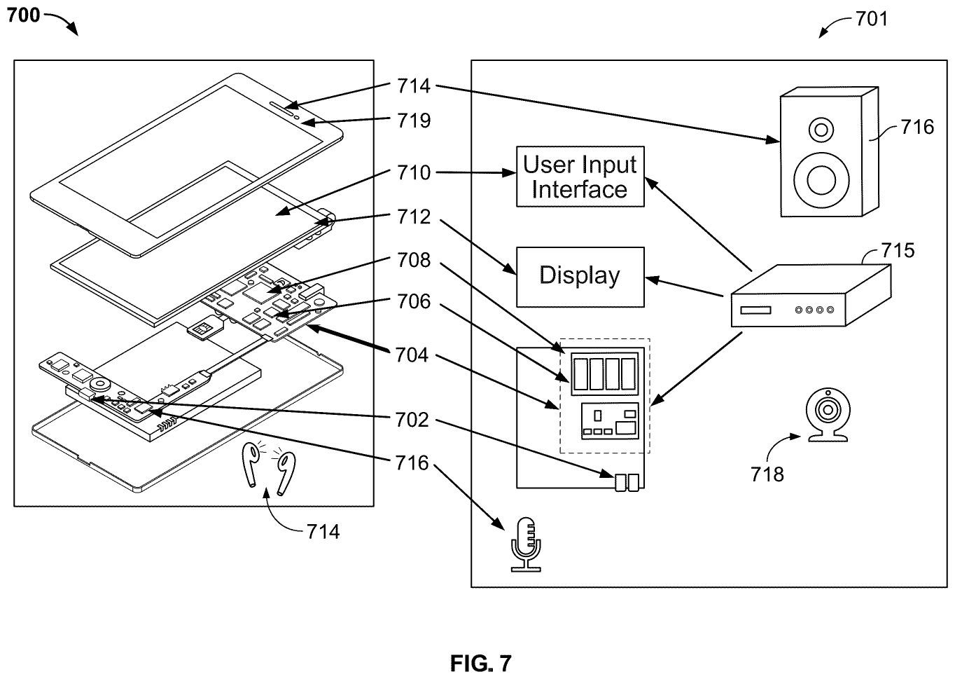

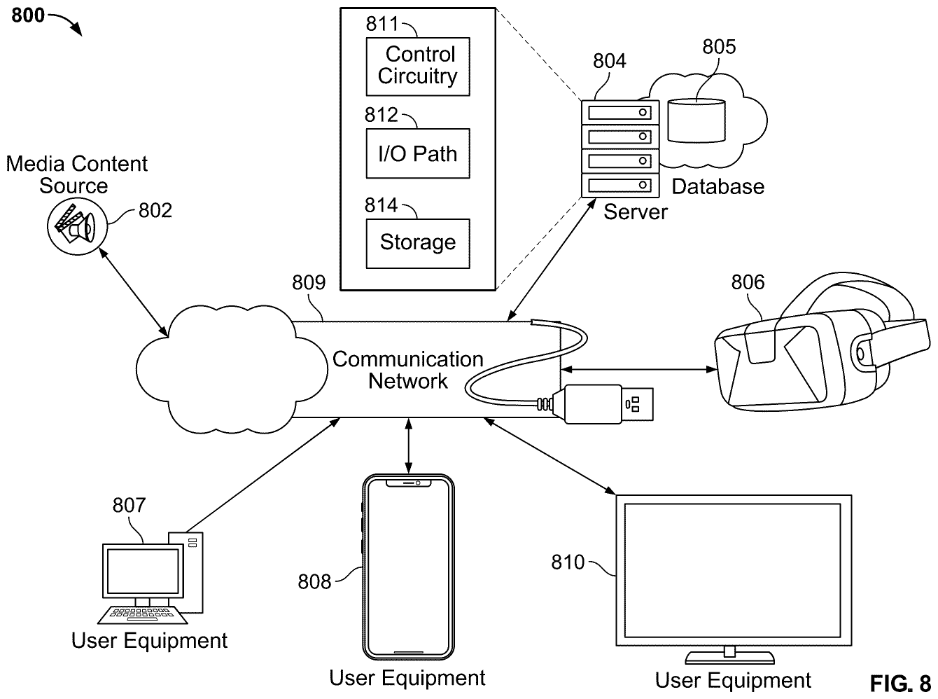

FIGS. 7-8 describe illustrative devices, systems, servers, and related hardware for subtly adjusting an image such that the adjusted image's vector representation aligns more closely with an intended search term and aligns less closely with a non-intended search term, in accordance with some embodiments of the present disclosure. FIG. 7 shows generalized embodiments of illustrative user equipment 700 and 701, which may correspond to, e.g., user equipment 110 of FIG. 1, and/or user device 202 of FIG. 2. For example, user equipment 700 may be a smartphone device, a tablet, a near-eye display device, an XR device, or any other suitable computing device capable of displaying an image, and/or receiving input regarding intended and/or non-intended search terms. In another example, user equipment 701 may be a desktop computer, a server, or any other suitable computing system. User equipment 701 may include computing device 715. Computing device 715 may be communicatively connected to microphone 716, audio output equipment (e.g., speaker or headphones 714), and display 712. In some embodiments, microphone 716 may receive audio corresponding to a voice of a video conference participant and/or ambient audio data during a video conference. In some embodiments, display 712 may be a television display or a computer display. In some embodiments, computing device 715 may be communicatively connected to user input interface 710. In some embodiments, user input interface 710 may be a remote-control device. Computing device 715 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 8. In some embodiments, device 700 may comprise any suitable number of sensors (e.g., gyroscope or gyrometer, or accelerometer, etc.), and/or a GPS module (e.g., in communication with one or more servers and/or cell towers and/or satellites) to ascertain a location of device 700. In some embodiments, device 700 comprises a rechargeable battery that is configured to provide power to the components of the device.

Each one of user equipment 700 and user equipment 701 may receive content and data via input/output (I/O) path 702. I/O path 702 may provide content (e.g., broadcast programming, on-demand programming, internet content, content available over a local area network (LAN) or wide area network (WAN), and/or other content) and data to control circuitry 704, which may comprise processing circuitry 707 and storage 708. Control circuitry 704 may be used to send and receive commands, requests, and other suitable data using I/O path 702, which may comprise I/O circuitry. I/O path 702 may connect control circuitry 704 (and specifically processing circuitry 707) to one or more communications paths (described below). I/O functions may be provided by one or more of these communications paths, but are shown as a single path in FIG. 7 to avoid overcomplicating the drawing. While computing device 715 is shown in FIG. 7 for illustration, any suitable computing device having processing circuitry, control circuitry, and storage may be used in accordance with the present disclosure. For example, computing device 715 may be replaced by, or complemented by, a personal computer (e.g., a notebook, a laptop, a desktop), a smartphone (e.g., device 700), an XR device, a tablet, a network-based server hosting a user-accessible client device, a non-user-owned device, any other suitable device, or any combination thereof.

Control circuitry 704 may be based on any suitable control circuitry such as processing circuitry 707. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In this disclosure, one or more of the functions or actions described above and below may be executed by a media application. That is, where an embodiment describes actions as being performed by one or more devices or systems, the actions may be performed by a media application running on one or more computing devices or systems. In some embodiments, control circuitry 704 executes instructions for the media application stored in memory (e.g., storage 708). Specifically, control circuitry 704 may be instructed by the media application to perform the functions discussed above and below. In some implementations, processing or actions performed by control circuitry 704 may be based on instructions received from the media application.

In client/server-based embodiments, control circuitry 704 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 7, the instructions may be stored in storage 708, and executed by control circuitry 704 of a device 700.

In some embodiments, the media application may be a client/server application where only the client application resides on device 700, and a server application resides on an external server (e.g., server 804). For example, the media application may be implemented partially as a client application on control circuitry 704 of device 700 and partially on server 804 as a server application running on control circuitry 811. Server 804 may be a part of a local area network with one or more of devices 800, 801 or may be part of a cloud computing environment accessed via the internet. In a cloud computing environment, various types of computing services for performing searches on the internet or informational databases, providing image analysis capabilities, providing storage (e.g., for a database), or parsing data are provided by a collection of network-accessible computing and storage resources (e.g., server 804 and/or an edge computing device), referred to as “the cloud.” Device 700 may be a cloud client that relies on the cloud computing capabilities from server 804 to execute the functions described herein with respect to images and image adjustment based on intended and non-intended search terms.

Control circuitry 704 may include communications circuitry suitable for communicating with a server, edge computing systems and devices, a table or database server, or other networks or servers. The instructions for carrying out the above mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of user equipment, or communication of user equipment in locations remote from each other (described in more detail below).

Memory may be an electronic storage device provided as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store various types of content described herein as well as media application data described above. Nonvolatile memory may also be used (e.g., to launch a boot-up routine and other instructions). Cloud-based storage, described in relation to FIG. 7, may be used to supplement storage 708 or instead of storage 708.

Control circuitry 704 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 704 may also include scaler circuitry for upconverting and downconverting content into the preferred output format of user equipment 700. Control circuitry 704 may also include digital-to-analog converter circuitry and analog-to-digital converter circuitry for converting between digital and analog signals. The tuning and encoding circuitry may be used by user equipment 700, 701 to receive and to display, to play, or to record content. The circuitry described herein may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 708 is provided as a separate device from user equipment 700, the tuning and encoding circuitry (including multiple tuners) may be associated with storage 708.

Control circuitry 704 may receive instruction from a user by way of user input interface 710. User input interface 710 may be any suitable user interface, such as a remote control, mouse, trackball, keypad, keyboard, touch screen, touchpad, stylus input, joystick, voice recognition interface, or other user input interfaces. Display 712 may be provided as a stand-alone device or integrated with other elements of each one of user equipment 700 and user equipment 701. For example, display 712 may be a touchscreen or touch-sensitive display. In such circumstances, user input interface 710 may be integrated with or combined with display 712. In some embodiments, user input interface 710 includes a remote-control device having one or more microphones, buttons, keypads, any other components configured to receive user input or combinations thereof. For example, user input interface 710 may include a handheld remote-control device having an alphanumeric keypad and option buttons. In a further example, user input interface 710 may include a handheld remote-control device having a microphone and control circuitry configured to receive and identify voice commands and transmit information to computing device 715.

Audio output equipment 714 may be integrated with or combined with display 712. Display 712 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 712. Audio output equipment 714 may be provided as integrated with other elements of each one of device 700 and device 701 or may be stand-alone units. An audio component of videos and other content displayed on display 712 may be played through speakers (or headphones) of audio output equipment 714. In some embodiments, audio may be distributed to a receiver (not shown), which processes and outputs the audio via speakers of audio output equipment 714. In some embodiments, for example, control circuitry 704 is configured to provide audio cues to a user, or other audio feedback to a user, using speakers of audio output equipment 714. There may be a separate microphone or audio output equipment 714 may include a microphone configured to receive audio input such as voice commands or speech. For example, a user may speak letters or words that are received by the microphone and converted to text by control circuitry 704. In a further example, a user may voice commands that are received by a microphone and recognized by control circuitry 704. Camera 718 may be any suitable video camera integrated with the equipment or externally connected. Camera 718 may be a digital camera comprising a charge-coupled device (CCD) and/or a complementary metal-oxide semiconductor (CMOS) image sensor. Camera 718 may be an analog camera that converts to digital images via a video card.

The media application configured to carry out the actions described above and below with respect to FIGS. 1-6 and 9 may be implemented using any suitable architecture. For example, it may be a stand-alone application wholly implemented on each one of user equipment 700 and user equipment 701. In such an approach, instructions of the application may be stored locally (e.g., in storage 708), and data for use by the application is downloaded on a periodic basis (e.g., from an out-of-band feed, from an internet resource, or using another suitable approach). Control circuitry 704 may retrieve instructions of the application from storage 708 and process the instructions to provide video conferencing functionality and generate any of the displays discussed herein. Based on the processed instructions, control circuitry 704 may determine what action to perform when input is received from user input interface 710. For example, movement of a cursor on a display up/down may be indicated by the processed instructions when user input interface 710 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 704 may allow a user to provide user profile information or may automatically compile user profile information. For example, control circuitry 704 may access and monitor network data, video data, audio data, processing data, and/or other data from a user. Control circuitry 704 may obtain all or part of other user profiles that are related to a particular user (e.g., via social media networks), and/or obtain information about the user from other sources that control circuitry 704 may access. As a result, a user can be provided with a unified experience across the user's different devices.

In some embodiments, the media application is a client/server-based application. Data for use by a thick or thin client implemented on each one of user equipment 700 and user equipment 701 may be retrieved on-demand by issuing requests to a server remote to each one of user equipment 700 and user equipment 701. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on device 700. This way, the processing of the instructions is performed remotely by the server while the resulting displays (e.g., that may include text, a keyboard, or other visuals) are provided locally on device 700. Device 700 may receive inputs from the user via input interface 710 and transmit those inputs to the remote server for processing and generating the corresponding displays. For example, device 700 may transmit a communication to the remote server indicating that intended and/or non-intended search terms have been selected via input interface 710 (e.g., as shown in FIG. 5). The remote server may process instructions in accordance with that input and generate a display of the application corresponding to the input. The generated display is then transmitted to device 700 for presentation to the user.

In some embodiments, the media application may be downloaded and interpreted or otherwise run by an interpreter or virtual machine (run by control circuitry 704). In some embodiments, the media application may be encoded in the ETV Binary Interchange Format (EBIF), received by control circuitry 704 as part of a suitable feed, and interpreted by a user agent running on control circuitry 704. For example, the media application may be an EBIF application. In some embodiments, the media application may be defined by a series of JAVA-based files that are received and run by a local virtual machine or other suitable middleware executed by control circuitry 704. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

As shown in FIG. 8, user equipment 806, 807, 808, 810 (which may correspond to, e.g., user equipment 110 of FIG. 1 or user equipment 202 of FIG. 2), may be coupled to communication network 809. Communication network 809 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 809) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 809.

System 800 may comprise one or more servers 804 and/or one or more edge computing devices. In some embodiments, the media application may be executed at one or more of control circuitry 811 of server 804 (and/or control circuitry of user equipment 806, 807, 808, 810 and/or control circuitry of one or more edge computing devices).

In some embodiments, server 804 may include control circuitry 811 and storage 814 (e.g., RAM, ROM, Hard Disk, Removable Disk, etc.). Storage 814 may store one or more databases. Server 804 may also include an I/O path 812. I/O path 812 may provide image adjustment data, intended and/or non-intended search term data (including search term similarity scores for each term), device information, or other data, over a local area network (LAN) or wide area network (WAN), and/or other content and data to control circuitry 811, which may include processing circuitry, and storage 814. Control circuitry 811 may be used to send and receive commands, requests, and other suitable data using I/O path 812, which may comprise I/O circuitry. I/O path 812 may connect control circuitry 811 (and specifically control circuitry) to one or more communications paths.

Control circuitry 811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 811 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 811 executes instructions for an emulation system application stored in memory (e.g., the storage 814). Memory may be an electronic storage device provided as storage 814 that is part of control circuitry 811.

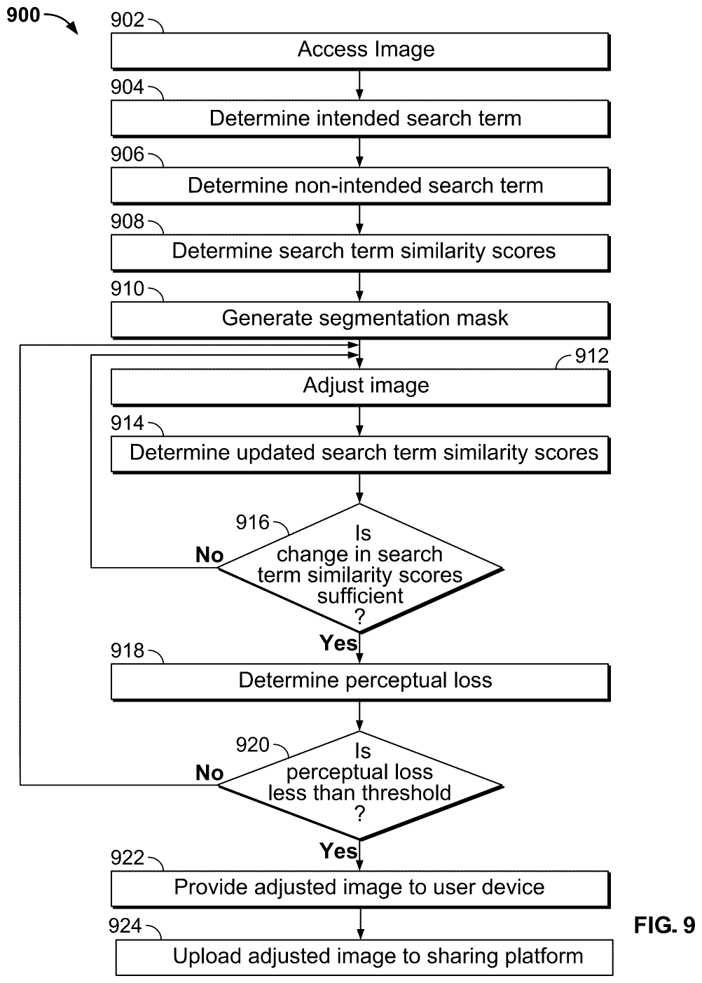

FIG. 9 is a flowchart of a detailed illustrative process 900 for adjusting or altering an image to more closely align its vector representation with one or more intended search terms, in accordance with some embodiments of this disclosure. In various embodiments, the individual steps of process 900 may be implemented by one or more components of the devices, systems and methods of FIGS. 1-8 and may be performed in combination with any of the other processes and aspects described herein. Although the present disclosure may describe certain steps of process 900 (and of other processes described herein) as being implemented by certain components of the devices, systems, and methods of FIGS. 1-8, this is for purposes of illustration only. It should be understood that other components of the devices, systems and methods of FIGS. 1-8 may implement those steps instead.

At 902, the process 900 includes a system (e.g., a system operating the media application described above) accessing an image. The image may be the initial image or input image 112, 204, 310, 410, 510, and/or 610 described above with respect to FIGS. 1-6. The image may be received from a user device (e.g., user device 110 and/or 202), and may be intended to be shared and be searchable via a sharing platform, which may be local (e.g., for storage and searching on a user's computing device), or for a wider audience (e.g., for storage and sharing on a social media site or search engine).

At 904 and 906, the process 900 includes the system determining one or more intended search terms and one or more non-intended search terms. As noted above, the intended and/or non-intended search terms may be input by a user via a user interface. In other embodiments, the search terms may be automatically determined by the system using, for example, machine vision or some other image analysis technique. In some embodiments, candidate search terms may be automatically determined by analyzing the image and/or image metadata. The candidate search terms may be presented to a user, and the user may select one or more of the candidate search terms as the intended and/or non-intended search terms. In some embodiments, only intended search terms may be provided or determined, while non-intended search terms are not provided or determined. In some examples, the user may also specify a perceptual loss threshold. The user may input an acceptable perceptual loss threshold, range, percentage, or other value that reflects the user's desired or acceptable perceptual loss between the input and output images. The user may also specify the perceptual loss threshold for one or more portions of the input image. For instance, the user may specify or identify a segmentation mask for the image, along with a desired perceptual loss threshold corresponding to the portion of the image covered by or associated with the segmentation mask.

At 908, the process 900 includes the system determining the search term similarity scores of the intended and/or non-intended search terms. This may include analyzing the input image and search terms using a discriminative model (e.g., discriminative model 124), to determine the similarity scores between the vector representation of the input image and the vector representation of the search terms. In some embodiments, the search term similarity scores may be presented via a user interface along with the input image, such as in a preview window of the user device.

At 910, the process 900 includes the system generating a segmentation mask. As noted above, particularly with respect to FIG. 3, the segmentation mask may be automatically generated based on the input image, the intended search terms, and/or the non-intended search terms. In some embodiments, the segmentation mask may also be generated based on user input, such as user selections of one or more portions of the input image, a user drawing on the input image, and/or a combination of automatic determination and user input (e.g., wherein the user refines or modifies an automatically generated segmentation mask).

At 912, the process 900 includes the system adjusting or altering the input image. This may include the system employing a generative model (e.g., model 122) to manipulate or adjust one or more pixels of the input image. As noted above, this adjustment may be performed based on a loss function having certain rewards and penalties. The loss function may reward adjustments that result in an increase in the similarity scores associated with the intended search terms, so as to reward adjustments that cause one or more of the intended search terms to have a higher similarity score with the adjusted image than with the input image. Alternatively or additionally, the loss function may penalize adjustments that result in an increase in the similarity scores associated with the non-intended search terms, so as to penalize adjustments that cause one or more of the non-intended search terms having a higher similarity score with the adjusted image than with the input image. Further, the loss function may penalize adjustments that result in an increase in the perceptual loss between the adjusted image and the input image, so as to penalize making changes to the image that are noticeable to the user.

At 914, the process 900 includes the system determining updated search term similarity scores for each of the intended and/or non-intended search terms. The system determines the updated search term similarity scores with respect to the adjusted image. This may be done using the same discriminative model that was used at step 908 (e.g., discriminative model 124).

At 916, the system determines whether the change in search term similarity scores is sufficient or satisfies predetermined criteria. In some embodiments, the system may use one or more thresholds with respect to changes in the search term similarity scores. That is, the system may require that greater than a threshold change in the search term similarity score for a given search term should occur, otherwise the system continues to adjust the image. The search term similarity score change threshold may be a default value, may be input by a user via a user interface (e.g., along with the intended and/or non-intended search terms), and/or may change based on the content of the image, the particular search terms, the position/coverage of the segmentation mask, etc. As noted above, there may be one or more thresholds, and/or one or more ways of measuring the change in the search term similarity scores (e.g., average change of all search terms, ranking terms and determining a weighted average change, etc.). If the change in search term similarity scores is below the required threshold, the process 900 returns to step 912 to perform further adjustments to the image.

At 918, the system determines the perceptual loss between the adjusted image and the input image. The system may determine the perceptual loss using any suitable calculation, such as the techniques described above with respect to FIGS. 1 and 3. Additionally, the system may use the segmentation mask in the perceptual loss calculation, so as to give greater weight to changes in certain portions of the image over others. That is, changes to portions of the image that are less relevant (e.g., background, noisy, etc.) may be less important than changes to the subject of the image (e.g., a person's face).

At 920, the system determines whether the perceptual loss is less than a perceptual loss threshold. As with the search term similarity score change threshold, the perceptual loss threshold may be determined based on a default, may be input by the user via a user interface, and/or may be dynamically determined based on various information such as the content of the image, the particular search terms, the position/coverage of the segmentation mask, etc. If the perceptual loss is too great (e.g., greater than the perceptual loss threshold), the process may proceed back to 912 to make further adjustments to the image, to reduce the perceptual loss while maintaining the change in search term similarity scores above the respective threshold.

At 922, if the change in search term similarity scores is above the respective threshold, and the perceptual loss is below the respective threshold, the system may output the adjusted image to the user device. The system may also provide the updated search term similarity scores with respect to the adjusted image, so as to illustrate to the user what has changed. FIGS. 4 and 5 provide example user interfaces showing the input and adjusted images, along with the respective search terms and search term similarity scores.

At 924, the adjusted image is uploaded to the sharing platform. The user may view the adjusted image on the user device, and may select or otherwise accept the adjusted image. The adjusted image may then automatically be uploaded to the sharing platform, or the user device may present an option for the user to select to upload the adjusted image. Alternatively, the user may request further adjustment or refinement of the entire image, or just certain selected areas of the image. The process 900 may then end.

It should be appreciated that the process 900 illustrates only one example, and the steps may be rearranged or carried out in a different order. Further, some steps may be performed simultaneously, such as the decisions made with respect to steps 916 and 920.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It should also be noted that the systems and/or methods described above may be applied to, or used in accordance with, other systems and/or methods. In various embodiments, additional elements may be included, some elements may be removed, and/or elements may be arranged differently from what is shown. Alterations, modifications, and variations can be affected to the particular embodiments by those of skill in the art without departing from the scope of the present application, which is defined solely by the claims appended hereto.

1. A method comprising:
accessing an image for upload to a sharing platform;
determining a first keyword indicated as an intended search term for the image;
determining a second keyword indicated as a non-intended search term for the image;
inputting the image to a machine learning system comprising a generative model and a discriminative model, wherein:
the generative model iteratively makes adjustments to the image to output an adjusted image, wherein the generative model modifies the adjustments to the image based on a loss function, and wherein the loss function is configured to:
reward adjustments that result in an increase in a first similarity score corresponding to the intended search term, wherein the first similarity score corresponds to a similarity between a vector representation of the adjusted image and a vector representation of the intended search term;
reward adjustments that result in a decrease in a second similarity score corresponding to the non-intended search term, wherein the second similarity score corresponds to a similarity between the vector representation of the adjusted image and a vector representation of the non-intended search term; and
penalize adjustments that result in an increase in perceptual loss of the adjusted image compared to the image; and
the discriminative model determines the first and second similarity scores based on the adjusted image, the intended search term, and the non-intended search term; and
causing the adjusted image to be uploaded to the sharing platform.

2. The method of claim 1, further comprising causing the adjusted image to be uploaded to the sharing platform based on:
determining that the first similarity score of the intended search term for the adjusted image is greater than the first similarity score of the intended search term for the image; and
determining that the second similarity score of the non-intended search term for the adjusted image is less than the second similarity score of the non-intended search term for the image.

3. The method of claim 1, further comprising:
determining a plurality of first keywords indicated as intended search terms for the image; and
determining a plurality of second keywords indicated as non-intended search terms for the image,
wherein the loss function is further configured to:
reward adjustments that result in an increase in the respective similarity scores corresponding to any of the intended search terms; and
reward adjustments that result in a decrease in the respective similarity scores corresponding to any of the non-intended search terms.

4. The method of claim 1, further comprising determining a segmentation mask for the image, wherein the generative model is configured to iteratively adjust the image based on the segmentation mask, wherein:
adjustments to a first portion of the image covered by the segmentation mask are prioritized over adjustments to a second portion of the image not covered by the segmentation mask.

5. The method of claim 4, wherein determining the segmentation mask for the image comprises automatically determining the segmentation mask based on the first keyword.

6. The method of claim 4, wherein determining the segmentation mask for the image comprises:
receiving input via a user interface of a selected portion of the image; and
determining the segmentation mask for the image based on the selected portion of the image.

7. The method of claim 1, further comprising:
determining a perceptual loss threshold; and
causing the adjusted image to be uploaded to the sharing platform based on determining that the perceptual loss of the adjusted image compared to the image is less than the perceptual loss threshold.

8. The method of claim 1, further comprising:
presenting, via a user interface, the image and the first keyword indicated as the intended search term for the image;
identifying, based on the image and the first keyword, a plurality of candidate second keywords;
receiving, via the user interface, a selected candidate second keyword of the plurality of candidate second keywords; and
identifying, as the second keyword indicated as the non-intended search term for the image, the selected candidate second keyword.

9. The method of claim 1, further comprising:
presenting, via a user interface, the image and the adjusted image;
presenting a prompt via the user interface for confirmation of the adjusted image; and
based on receiving confirmation of the adjusted image via the user interface, causing the adjusted image to be uploaded to the sharing platform.

10. The method of claim 1, wherein the generative model is configured to iteratively adjust the image by changing the color of one or more pixels of the image.

11. A system comprising:
input/output circuitry configured to:
access an image for upload to a sharing platform; and
control circuitry configured to:
determine a first keyword indicated as an intended search term for the image;
determine a second keyword indicated as a non-intended search term for the image;
input the image to a machine learning system comprising a generative model and a discriminative model, wherein:
the generative model iteratively makes adjustments to the image to output an adjusted image, wherein the generative model modifies the adjustments to the image based on a loss function, and wherein the loss function is configured to:
reward adjustments that result in an increase in a first similarity score corresponding to the intended search term, wherein the first similarity score corresponds to a similarity between a vector representation of the adjusted image and a vector representation of the intended search term;
reward adjustments that result in a decrease in a second similarity score corresponding to the non-intended search term, wherein the second similarity score corresponds to a similarity between the vector representation of the adjusted image and a vector representation of the non-intended search term; and
penalize adjustments that result in an increase in perceptual loss of the adjusted image compared to the image; and
the discriminative model determines the first and second similarity scores based on the adjusted image, the intended search term, and the non-intended search term; and
cause the adjusted image to be uploaded to the sharing platform.

12. The system of claim 11, wherein the control circuitry is further configured to cause the adjusted image to be uploaded to the sharing platform based on:
determining that the first similarity score of the intended search term for the adjusted image is greater than the first similarity score of the intended search term for the image; and
determining that the second similarity score of the non-intended search term for the adjusted image is less than the second similarity score of the non-intended search term for the image.

13. The system of claim 11, wherein the control circuitry is further configured to:
determine a plurality of first keywords indicated as intended search terms for the image; and
determine a plurality of second keywords indicated as non-intended search terms for the image,
wherein the loss function is further configured to:
reward adjustments that result in an increase in the respective similarity scores corresponding to any of the intended search terms; and
reward adjustments that result in a decrease in the respective similarity scores corresponding to any of the non-intended search terms.

14. The system of claim 11, wherein the control circuitry is further configured to determine a segmentation mask for the image, wherein the generative model is configured to iteratively adjust the image based on the segmentation mask, wherein:
adjustments to a first portion of the image covered by the segmentation mask are prioritized over adjustments to a second portion of the image not covered by the segmentation mask.

15. The system of claim 14, wherein the control circuitry is further configured to determine the segmentation mask for the image by automatically determining the segmentation mask based on the first keyword.

16. The system of claim 14, wherein the control circuitry is further configured to determine the segmentation mask for the image by:
receiving input via a user interface of a selected portion of the image; and
determining the segmentation mask for the image based on the selected portion of the image.

17. The system of claim 11, wherein the control circuitry is further configured to:
determine a perceptual loss threshold; and
causing the adjusted image to be uploaded to the sharing platform based on determining that the perceptual loss of the adjusted image compared to the image is less than the perceptual loss threshold.

18. The system of claim 11, wherein:
the input/output circuitry is further configured to:
present, via a user interface, the image and the first keyword indicated as the intended search term for the image; and
the control circuitry is further configured to identify, based on the image and the first keyword, a plurality of candidate second keywords,
wherein the input/output circuitry is further configured to:
receive, via the user interface, a selected candidate second keyword of the plurality of candidate second keywords, and
wherein the control circuitry is further configured to identify, as the second keyword indicated as the non-intended search term for the image, the selected candidate second keyword.

19. The system of claim 11, wherein:
the input/output circuitry is further configured to:
present, via a user interface, the image and the adjusted image; and
present a prompt via the user interface for confirmation of the adjusted image; and
the control circuitry is further configured to:
based on receiving confirmation of the adjusted image via the user interface, cause the adjusted image to be uploaded to the sharing platform.

20. The system of claim 11, wherein the generative model is configured to iteratively adjust the image by changing the color of one or more pixels of the image.

21-50. (canceled)
